(19) United States
(12) Patent Application Publication
(10) Pub. No.: US 2021/0089044 A1
(43) Pub. Date: Mar. 25, 2021

(54) METHOD FOR CONTROLLING A MOTOR VEHICLE REMOTELY

(71) Applicant: Robert Bosch GmbH, Stuttgart (DE)

(72) Inventor: Stefan Nordbruch, Kornwestheim (DE)

(21) Appl. No.: 17/023,936

(22) Filed: Sep. 17, 2020

(30) Foreign Application Priority Data
Sep. 23, 2019 (DE) 102019214433.0

(51) Int. Cl. G05D 1/02; G05D 1/00

(52) U.S. Cl. CPC G05D 1/0223; G05D 1/0022; G05D 2201/0213; G05D 1/0061; G05D 1/0016

(57) ABSTRACT

A method for controlling a motor vehicle remotely. The method includes: receiving motor vehicle speed signals, which represent a speed of a motor vehicle; receiving maximum motor vehicle speed signals, which represent a predetermined maximum speed of a motor vehicle; comparing the motor vehicle speed to the predetermined maximum motor vehicle speed; generating remote control signals for controlling the motor vehicle remotely on the basis of a result of the comparison; and outputting the generated remote control signals. A device, a computer program and a machine-readable storage medium are also described.

### CROSS REFERENCE

The present application claims the benefit under 35 U.S.C. § 119 of German Patent Application No. 102019214433.0 filed on Sep. 23, 2019, which is expressly incorporated herein by reference in its entirety.

### FIELD

The present invention relates to a method for controlling a motor vehicle remotely. In addition, the present invention relates to a device, a computer program and a machine-readable storage medium.

### BACKGROUND INFORMATION

Conventionally, on a road, a motor vehicle may have, e.g., only a certain, maximum speed; therefore, this means that a speed restriction may be in force for a road.

Compliance with a speed restriction may be monitored, for example, with the aid of a radar installation.

German Patent Application No. DE 10 2018 100 112 A1 describes a method and a system for processing local and cloud data in a vehicle.

German Patent Application No. DE 10 2018 120 899 A1 describes the blocking of a highway assistance mode.

PCT Application No. WO 2019/028464 A1 describes a motor vehicle having an assistance system.

### SUMMARY

An object of the present invention is to provide for efficiently controlling a motor vehicle remotely, which allows a speed restriction for motor vehicles to be enforced efficiently.

This object may be achieved with the aid of example embodiments of the present invention. Advantageous refinements of the present invention are described herein.

According to one aspect of the present invention, a method for controlling a motor vehicle remotely is provided. In an example embodiment of the present invention, the method includes the following steps:

receiving motor vehicle speed signals, which represent a speed of a motor vehicle;
receiving maximum motor vehicle speed signals, which represent a predetermined maximum speed of a motor vehicle;
comparing the motor vehicle speed to the predetermined maximum motor vehicle speed;
generating remote control signals for controlling the motor vehicle remotely on the basis of a result of the comparison; and
outputting the generated remote control signals.

According to a second aspect of the present invention, a device is provided, which is configured to execute all of the steps of the method according to the first aspect.

According to a third aspect of the present invention, a computer program is provided, which includes commands that, in response to the execution of the computer program by a computer, for example, by the device according to the second aspect, cause it to implement a method according to the first aspect.

According to a fourth aspect of the present invention, a machine-readable storage medium is provided, in which the computer program according to the third aspect is stored.

In accordance with the present invention, in response to a motor vehicle speed which exceeds the predetermined maximum motor vehicle speed, the above-mentioned object may be achieved by assuming remote control over the motor vehicle, in particular, even while the motor vehicle is moving. Thus, in particular, this means that the motor vehicle is checked or controlled remotely, if the motor vehicle speed is greater than the predetermined maximum motor vehicle speed.

This produces, for example, the technical advantage that a speed restriction for motor vehicles may be checked or enforced in an efficient manner. Thus, for example, this allows the motor vehicle to be efficiently prevented from continuing to travel at a motor vehicle speed, which is greater than the predetermined maximum motor vehicle speed.

This prevention further produces, in particular, the technical advantage that due to a motor vehicle speed, which is greater than the predetermined maximum motor vehicle speed, further road users in the surroundings of the motor vehicle may be put at risk.

Therefore, the predetermined, maximum motor vehicle speed is, in particular, a permissible, maximum motor vehicle speed. In this case, permissible relates to, in particular, a legal requirement or a legal regulation.

The predetermined maximum motor vehicle speed may be in force, e.g., for a road, on which the motor vehicle is currently traveling. The predetermined maximum motor vehicle speed may be in force, e.g., for a restricted geographic region, within which the motor vehicle is currently situated or is currently traveling.

For example, the predetermined maximum motor vehicle speed is a function of a type of the motor vehicle.

Therefore, this means, in particular, that different maximum motor vehicle speeds are designated for different types of motor vehicles.

A type may be, e.g., a cargo truck, a passenger car, a motor vehicle having a trailer, a motorcycle or a two-wheeled vehicle.

Consequently, this may produce, in particular, the technical advantage that a concept is provided, which efficiently allows a speed restriction for a road or for a restricted geographic region to be monitored and enforced in an efficient manner.

According to one specific embodiment of the present invention, the remote control signals include control signals for controlling a lateral and/or longitudinal guidance of the motor vehicle, in order to control the lateral and/or longitudinal guidance of the motor vehicle remotely during remote control of the motor vehicle on the basis of the remote control signals.

According to one specific embodiment of the present invention, the remote control signals include control signals for controlling a lateral and/or longitudinal guidance of the motor vehicle, in order to control the lateral and longitudinal guidance of the motor vehicle remotely during remote control of the motor vehicle on the basis of the remote control signals.

This may produce, e.g., the technical advantage that the motor vehicle may be controlled remotely in an efficient manner; in particular, this produces the technical advantage that the motor vehicle may be checked remotely in an efficient manner.

In the case in which the remote control signals include control signals for controlling the lateral or the longitudinal guidance of the motor vehicle, one specific embodiment provides that in each instance, the other guidance, that is, the longitudinal guidance or the lateral guidance, be either controlled manually by the driver (which may then be referred to, in particular, as assisted driving), or controlled in an at least semiautomated manner, in order to drive the motor vehicle in an at least semiautomated manner.

Assisted driving means, in particular, that a driver of the motor vehicle permanently carries out either the lateral or the longitudinal guidance of the motor vehicle. The other respective driving task (that is, controlling the longitudinal or the lateral guidance of the motor vehicle) is carried out remotely in an automatic manner. Therefore, this means that in the case of assisted driving of the motor vehicle, either the lateral or the longitudinal guidance is controlled remotely in an automatic manner.

The wording “at least semiautomated driving” includes one or more of the following cases: semiautomated driving, highly automated driving, fully automated driving.

Semiautomated driving means that in a specific situation (for example: driving on an expressway, driving within a parking lot, passing an object, driving within a traffic lane, which is defined by lane markings) and/or for a certain period of time, longitudinal and lateral guidance of the motor vehicle are controlled remotely in an automatic manner. A driver of the motor vehicle does not have to manually control the longitudinal and lateral guidance of the motor vehicle himself/herself. However, the driver must monitor the automatic, remote control of the longitudinal and lateral guidance continuously, in order to be able to manually intervene, if necessary. The driver must be ready to completely take over the driving of the motor vehicle at any time.

Highly automated driving means that for a certain period of time, in a specific situation (for example: driving on an expressway, driving within a parking lot, passing an object, driving within a traffic lane, which is defined by lane markings), longitudinal and lateral guidance of the motor vehicle are controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance continuously, in order to be able to intervene manually, as required. If necessary, a take-over request to the driver for assuming the control of the longitudinal and lateral guidance is outputted automatically, in particular, outputted with adequate time to spare. Thus, the driver must be potentially able to take over the control of the longitudinal and lateral guidance. Limits of the automatic, remote control of the lateral and longitudinal guidance are detected automatically. In the case of highly automated driving, it is not possible to bring about a minimum-risk state automatically in every initial situation.

Fully automated driving means that in a specific situation (for example: driving on an expressway, driving within a parking lot, passing an object, driving within a traffic lane, which is defined by lane markings), longitudinal and lateral guidance of the motor vehicle is controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance, in order to be able to intervene manually, when necessary. Prior to an end of the automatic, remote control of the lateral and longitudinal guidance, a request for the driver to take over the driving task (controlling the lateral and longitudinal guidance of the motor vehicle) is made automatically, in particular, with adequate time to spare. If the driver does not assume the driving task, then a return is made automatically to a minimum-risk state. Limits of the automatic control of the lateral and longitudinal guidance are detected automatically. In all situations, it is possible to return automatically to a minimum-risk system state.

According to one specific embodiment of the present invention, if the result of the comparison indicates that the motor vehicle speed is greater than the predetermined maximum motor vehicle speed, the control signals are generated in such a manner, that in the case of the remote control of the lateral and/or longitudinal guidance of the motor vehicle on the basis of the generated remote control signals, the motor vehicle is decelerated until the motor vehicle has a reduced motor vehicle speed, which is less than or less than or equal to the predetermined maximum motor vehicle speed.

This may produce, for example, the technical advantage that the motor vehicle speed may be reduced in an efficient manner. In particular, this may advantageously produce, in particular, the technical advantage that the speed restriction may be enforced in an efficient manner.

According to one specific embodiment of the present invention, if the result of the comparison indicates that the motor vehicle speed is greater than the predetermined maximum motor vehicle speed, the control signals are generated in such a manner, that in the case of the remote control of the lateral and/or longitudinal guidance of the motor vehicle on the basis of the generated remote control signals, the motor vehicle stops in a predetermined area.

A technical advantage of this is, for example, that the speed restriction may be enforced efficiently. In particular, this efficiently allows the motor vehicle to be prevented from traveling on.

The predetermined area is, e.g., a parking space.

According to one specific embodiment of the present invention, the remote control signals include control signals for a human-machine interface of the motor vehicle, in order, in the case of remote control of the human-machine interface on the basis of the control signals, to output a signal with the aid of the human-machine interface; the signal representing the result of the comparison.

This may produce, for example, the technical advantage that the result of the comparison may be communicated to a motor vehicle occupant in an efficient manner.

Consequently, if the result indicates that the motor vehicle speed is greater than the predetermined maximum motor vehicle speed, a driver of the motor vehicle may efficiently be given the option of reducing the motor vehicle speed himself/herself, by braking the motor vehicle. Then, e.g., a lateral and/or longitudinal guidance of the motor vehicle does not have to be controlled remotely, for example, in order to stop or decelerate the motor vehicle.

Control from a distance is remote control.

According to one specific embodiment of the present invention, if the result of the comparison indicates that the motor vehicle speed is greater than the predetermined maximum motor vehicle speed, then further motor vehicle speed signals, which represent a further motor vehicle speed of the motor vehicle, are received temporally subsequent to the outputting of the remote control signals; the further motor vehicle speed being compared further to the predetermined maximum motor vehicle speed; further remote control signals for controlling the motor vehicle remotely on the basis of a result of the further comparison being generated; and the generated, further remote control signals being outputted.

This produces, for example, the technical advantage that a behavior of the motor vehicle after the communication of the result of the comparison may be monitored efficiently. Thus, in this manner, in particular, it may be efficiently monitored if, after the communication of the result of the comparison, a driver of the motor vehicle decelerates the vehicle, that is, drives according to the requirement, in conformance with the predetermined maximum motor vehicle speed.

If, e.g., the result of the further comparison indicates that the further motor vehicle speed continues to be greater than the predetermined maximum motor vehicle speed, then, e.g., the further remote control signals include further control signals in such a manner, that in the case of remote control of the lateral and/or longitudinal guidance of the motor vehicle on the basis of the generated, further remote control signals, the motor vehicle is decelerated until the motor vehicle has a reduced motor vehicle speed, which is less than or less than or equal to the predetermined maximum motor vehicle speed, and/or until the motor vehicle stops in a predetermined area.

Variants of the present invention, which are made in connection with the remote control signals or control signals, apply analogously to the further remote control signals or further control signals, and vice versa.

According to one specific embodiment of the present invention, surrounding-area signals are received, which represent a surrounding area of the motor vehicle; the remote control signals being generated on the basis of the surrounding area.

This may produce, for example, the technical advantage that the remote control signals, in particular, the control signals, may be generated efficiently. In particular, this produces the technical advantage that a surrounding area of the motor vehicle may be taken into account efficiently during the generation of the remote control signals, in particular, of the control signals.

According to one specific embodiment of the present invention, it is checked, on the basis of the surrounding area of the motor vehicle, if a current traffic situation permits remote control of the motor vehicle. In particular, the control signals are generated or outputted on the basis of a result of the check as to whether the current traffic situation permits remote control.

For example, remote control of the motor vehicle is refrained from, if the current traffic situation does not permit remote control.

This may produce, for example, the technical advantage that other road users in the surroundings of the motor vehicle are not put at risk or injured.

According to one specific embodiment of the present invention, safety condition signals are received, which represent at least one safety condition that must be satisfied, so that the motor vehicle may be controlled remotely; it being checked if the at least one safety condition is satisfied; and the remote control signals being generated on the basis of a result of the check as to whether the at least one safety condition is satisfied.

This may produce, for example, the technical advantage that the remote control signals may be generated efficiently. In particular, this produces the technical advantage that it may be ensured, in an efficient manner, that certain conditions, presently, the at least one safety condition, are satisfied for controlling the motor vehicle remotely. Consequently, in particular, the technical advantage is produced, that if the safety condition is met, the remote control of the motor vehicle is then safely possible.

According to one specific embodiment of the present invention, it is provided that the at least one safety condition be, in each instance, an element selected from the following group of safety conditions: presence of a predetermined safety integrity level (SIL) or automotive safety integrity level (ASIL) of at least the motor vehicle and an infrastructure, in particular, including a communication path and/or communications components (for example, a communications interface), for controlling a motor vehicle remotely (in particular, with regard to the overall systems in the motor vehicle and infrastructure, as well as, in particular, parts, e.g., components, algorithms, interfaces, etc.; presence of a maximum latency time of a communication between the motor vehicle and a remote control device for controlling the motor vehicle remotely on the basis of the remote control signals; presence of a predetermined computer protection level of a device for executing the steps of the method according to the first aspect; presence of predetermined components and/or algorithms and/or communication options, which are used for executing the steps of the method according to the first aspect; presence of redundancy and/or diversity in predetermined components and/or algorithms and/or communication options, which are used for executing the steps of the method according to the first aspect; presence of predetermined availability information, which indicates an availability of predetermined components and/or algorithms and/or communication options; presence of predetermined quality criteria of the predetermined components and/or algorithms and/or communication options; presence of a plan, which includes measures for reducing faults, and/or measures in response to failures of predetermined components and/or algorithms and/or communication options, and/or measures for incorrect analyses and/or measures in response to incorrect interpretations; presence of one or more fallback scenarios; presence of a predetermined function; presence of a predetermined traffic situation; presence of predetermined weather, maximum possible time for a specific performance or execution of one step or a plurality of steps of the method according to the first aspect; presence of a test result, that elements or functions, which are used for executing the method according to the first aspect, are presently functioning correctly.

A communication path is, for example, a communication path between the device according to the second aspect, and the motor vehicle. A communication path includes, for example, one or more communication channels.

In one specific embodiment of the present invention, a component, which is used for executing the method according to the first aspect, is an element selected from the following group of components: surround sensor, motor vehicle, infrastructure, remote control device, device according to the second aspect, motor vehicle system, in particular, drive system, clutch system, brake system, driver assistance system, communications interface of the motor vehicle or of the infrastructure, processor, input, output of the device according to the second aspect.

In one specific embodiment of the present invention, a function, which is used for executing the method according to the first aspect, is an element selected from the following group of functions: remote control function, communication function between the motor vehicle and the infrastructure or the remote control device, evaluation function of surround sensor data of a surround sensor, planning function, in particular, travel planning function, traffic analysis function.

The following determines, in particular, a computer protection level: activated firewall and/or valid encryption certificate for encryption of a communication between the motor vehicle and the infrastructure or the remote control device, and/or activated virus program including current virus signatures, and/or presence of a protection, in particular, mechanical protection, in particular, anti-intrusion protection, of the computer, in particular, of the device according to the second aspect, or of the remote control device, and/or presence of an option for checking that signals, in particular, remote control signals or surrounding-area signals, have been transmitted correctly, that is, error-free.

An algorithm includes, for example, the computer program according to the third aspect.

Since, in particular, it is checked that redundancy and/or diversity is present in predetermined components and/or algorithms and/or communication options, for example, the technical advantage is provided, that in the case of failure of the corresponding component, for example, of a computer, or of the corresponding algorithm or the corresponding communication option, nevertheless, safe functioning may be implemented.

In order to ensure that results are correct, according to one specific embodiment of the present invention, these may be computed several times, for example, and the corresponding results may be compared to each other. For example, it is only determined that the results are correct, if the results agree. If an odd number occurs several times, it may then be determined, for example, that the result corresponding to the highest number of equal results is correct.

For example, remote control signals are only generated, when it is able to be determined that the result is correct.

In one specific embodiment of the present invention, the remote control signals are only generated, if the at least one safety condition is satisfied.

In one specific embodiment of the present invention, the check as to whether the at least one safety condition is satisfied, is carried out prior to and/or after and/or during one or more predetermined method steps.

In particular, this may produce the technical advantage that it may be ensured in an efficient manner, that certain conditions, presently, the safety condition, are satisfied for controlling the motor vehicle remotely prior to and/or after and/or during the execution of the corresponding method steps. Consequently, in particular, the technical advantage is produced, that if the safety condition is met, the remote control of the motor vehicle is then safely possible.

In one specific embodiment of the present invention, it is provided that after the outputting of the remote control signals, remote control of the motor vehicle on the basis of the outputted remote control signals is checked, in order to detect a fault; in response to the detection of a fault, the remote control being interrupted, or emergency remote control signals for controlling the motor vehicle remotely in an emergency being generated and outputted.

According to one specific embodiment of the present invention, the emergency remote control signals include emergency control signals for controlling the lateral and/or longitudinal guidance of the motor vehicle remotely. The emergency control signals are, for example, such, that in the case of the remote control of the lateral and/or longitudinal guidance of the motor vehicle, the motor vehicle is carried over into a safe state, in particular, stopped.

Variants, which are made in connection with the remote control signals, in particular, with the control signals, apply analogously to the emergency remote control signals, in particular, the emergency control signals, and vice versa.

According to one specific embodiment of the present invention, one or more method steps up to the steps of generating and outputting the remote control signals are executed in the motor vehicle, and/or one or more method steps are executed outside of the motor vehicle, in particular, in an infrastructure, preferably, in a cloud infrastructure.

This may produce, for example, the technical advantage that the corresponding method steps may be carried out in an efficiently redundant manner. In particular, this may further increase safety in an advantageous manner.

According to one specific embodiment of the present invention, one or more method steps are documented, in particular, documented in a blockchain.

The technical advantage of this is, for example, that on the basis of the documentation, this may also be analyzed subsequently after the performance or execution of the method.

In particular, the documentation in a blockchain has the technical advantage that the documentation is safe from manipulation and falsification.

A blockchain (also block chain) is, in particular, a continuously expandable list of data records, called blocks, which are linked together with the aid of one or more cryptographic methods. In this context, each block contains, in particular, a cryptographically secure hash (standard value of deviation) of the preceding block, in particular, a time stamp and, in particular, transactional data.

According to one specific embodiment of the present invention, it is provided that the method according to the first aspect be a computer-implemented method.

According to one specific embodiment of the present invention, the method according to the first aspect is executed or performed with the aid of the device according to the second aspect.

Device features follow analogously from corresponding method features, and vice versa. Thus, this means that, in particular, technical functions of the device according to the second aspect follow analogously from corresponding instances of technical functionality of the method according to the first aspect, and vice versa.

The wording “at least one” stands, in particular, for “one or more.”

Exemplary embodiments of the present invention are represented in the figures and explained in greater detail below.

### BRIEF DESCRIPTION OF THE DRAWINGS

FIG. 1 shows a flow chart of a method for controlling a motor vehicle remotely in accordance with an example embodiment of the present invention.

FIG. 2 shows a device in accordance with an example embodiment of the present invention.

FIG. 3 shows a machine-readable storage medium in accordance with an example embodiment of the present invention.

### DETAILED DESCRIPTION OF EXAMPLE EMBODIMENTS

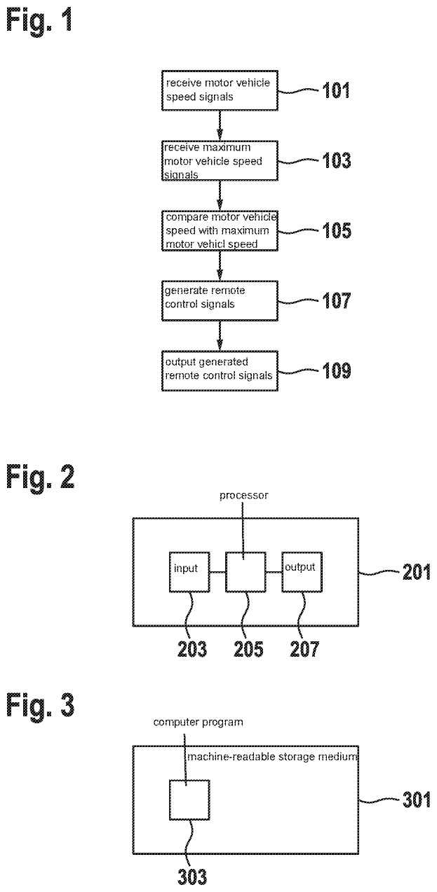

FIG. 1 shows a flow chart of a method for controlling a motor vehicle remotely, including the following steps:

receiving 101 motor vehicle speed signals, which represent a speed of a motor vehicle;
receiving 103 maximum motor vehicle speed signals, which represent a predetermined maximum speed of a motor vehicle;
comparing 105 the motor vehicle speed to the predetermined maximum motor vehicle speed;
generating 107 remote control signals for controlling the motor vehicle remotely on the basis of a result of the comparison; and
outputting 109 the remote control signals generated.

A result of the comparison indicates, e.g., that the motor vehicle speed is greater than or greater than or equal to the predetermined maximum motor vehicle speed.

A result of the comparison indicates, e.g., that the motor vehicle speed is less than or less than or equal to the predetermined maximum motor vehicle speed.

According to one specific embodiment of the present invention, remote control signals for controlling the motor vehicle remotely are only generated, if the result indicates that the motor vehicle speed is greater than the predetermined maximum motor vehicle speed.

Thus, this means, in particular, that a remote intervention in the operation of the motor vehicle is only carried out, if the motor vehicle speed is greater than the predetermined maximum motor vehicle speed.

Thus, this means, in particular, that in the case of a motor vehicle speed, which is less than or less than or equal to the predetermined maximum motor vehicle speed, no remote control signals for controlling the motor vehicle remotely are generated.

According to one specific embodiment of the present invention, remote control signals for controlling the motor vehicle remotely are only generated, if the result indicates that the motor vehicle speed is greater than the predetermined maximum motor vehicle speed by more than a predetermined speed tolerance amount.

Thus, this means, in particular, that a remote intervention in the operation of the motor vehicle is only carried out, if the motor vehicle speed is greater than the predetermined maximum motor vehicle speed by more than a predetermined speed tolerance amount.

The predetermined speed tolerance amount is, for example, a specified percentage, for example, 10%, relative to the predetermined maximum motor vehicle speed.

The predetermined speed tolerance amount is, for example, an absolute value, for example, 5 km/h, for example, 10 km/h.

For example, the provision of a predetermined speed tolerance amount produces the technical advantage, that any inaccuracies in the measuring or determining of the motor vehicle speed may be taken into account in an efficient manner.

FIG. 2 shows a device 201 in accordance with an example embodiment of the present invention.

Device 201 is configured to execute all of the steps of the method according to the first aspect.

Device 201 includes an input 203, which is configured to receive the motor vehicle speed signals and the maximum motor vehicle speed signals.

Device 201 further includes a processor 205, which is configured to compare the motor vehicle speed to the predetermined maximum motor vehicle speed. Processor 205 is further configured to generate the remote control signals for controlling the motor vehicle remotely, based on a result of the comparison.

Device 201 further includes an output 207, which is configured to output the remote control signals generated.

According to one specific embodiment of the present invention, for example, outputting the generated remote control signals includes transmitting the remote control signals over a communications network, in particular, over a wireless communications network, to the motor vehicle.

According to one specific embodiment of the present invention, the method according to the first aspect includes controlling the motor vehicle remotely on the basis of the generated remote control signals.

In general, signals, which are received, are received with the aid of input 203. Thus, input 203 is configured, in particular, to receive the corresponding signals. In general, signals, which are outputted, are outputted with the aid of output 207. Thus, output 207 is configured, in particular, to output the corresponding signals.

According to one specific embodiment of the present invention, a plurality of processors are provided in place of the one processor 205.

According to one specific embodiment of the present invention, processor 205 is configured to execute the preceding and/or subsequent generating and checking steps.

FIG. 3 shows a machine-readable storage medium 301 in accordance with an example embodiment of the present invention.

A computer program 303 is stored in machine-readable storage medium 301; the computer program including commands, which, in response to execution of computer program 303 by a computer, cause it to implement a method according to the first aspect.

According to one specific embodiment of the present invention, device 201 includes a remote control device, which is configured to control the motor vehicle remotely on the basis of the remote control signals generated.

According to one specific embodiment of the present invention, an infrastructure or an infrastructure system is provided, which includes, for example, the device according to the second aspect.

For example, the infrastructure monitors a geographic region to the effect that a motor vehicle situated inside of the geographic region maintains a predetermined maximum motor vehicle speed.

For example, the infrastructure includes a road, on which, for example, a motor vehicle is traveling. The infrastructure monitors the motor vehicle, so that the motor vehicle maintains a predetermined maximum motor vehicle speed.

For this monitoring, according to one specific embodiment, one or more surround sensors are provided, which are positioned so as to be spatially distributed within the infrastructure, in particular, within the geographic region or, for example, along the road.

For example, the region includes the road.

For example, a surround sensor is one of the following surround sensors: radar sensor, lidar sensor, video sensor, ultrasonic sensor, magnetic field sensor and infrared sensor.

A surround sensor may be used, for example, in order to detect a motor vehicle and/or to measure or determine its speed. This means, in particular, that according to one specific embodiment, surround sensor data are received from one or more surround sensors of the infrastructure; the surround sensor data being processed, in order to detect a motor vehicle and/or to measure or determine its speed. In particular, the method according to the first aspect is initiated in response to the detection of a motor vehicle. Thus, this means, in particular, that in response to the detection of a motor vehicle, the steps 101, 103, 105 described above are executed, and depending on the result, steps 107 and 109 are executed.

According to one specific embodiment of the present invention, a motor vehicle travels within a restricted geographic region or on a road, for which there is a speed restriction. Thus, this means that a predetermined maximum motor vehicle speed is permitted for the region or the road.

According to one specific embodiment of the present invention, the motor vehicle is connected to the infrastructure so as to be able to communicate; or the motor vehicle is connected, in particular, automatically, to the system or the infrastructure, so as to be able to communicate automatically.

According to one specific embodiment of the present invention, the motor vehicle emits a signal, in particular, a position signal, and may be detected in this manner.

According to one specific embodiment of the present invention, the motor vehicle is detected, in particular, by the infrastructure, using, for example, one or more surround sensors, for example, using visual methods, such as license plate detection.

According to one specific embodiment of the present invention, the requirement (speed restriction, that is, the predetermined maximum motor vehicle speed) is analyzed or checked, in particular, by the infrastructure.

For this, e.g., the motor vehicle speed may be transmitted by the motor vehicle and/or retrieved by the motor vehicle.

Therefore, this means, in particular, that request signals, which represent a request to the motor vehicle for the motor vehicle speed, are generated and outputted.

According to one specific embodiment of the present invention, data of the motor vehicle are compared to data from a cloud system, in order to prevent improper use. Such data include, for example, information as to whether the motor vehicle is actually capable of traveling at the predetermined maximum motor vehicle speed. This information may be derived, for example, from the general data of the motor vehicle.

According to one specific embodiment of the present invention, the motor vehicle speed is compared to the predetermined maximum motor vehicle speed.

If a result of the comparing or the comparison indicates that the motor vehicle speed is greater than the maximum motor vehicle speed, then, according to one specific embodiment, one or more of the following actions are performed or executed:

One action includes, for example, the following: Generating remote control signals for controlling the motor vehicle remotely on the basis of a result of the comparison, and outputting the generated remote control signals.

According to one specific embodiment of the present invention, if the result of the comparison indicates that the motor vehicle speed is greater than the predetermined maximum motor vehicle speed, the remote control signals include control signals, which are generated in such a manner, that in the case of the remote control of the lateral and/or longitudinal guidance of the motor vehicle on the basis of the generated remote control signals, the motor vehicle is decelerated until the motor vehicle has a reduced motor vehicle speed, which is less than or less than or equal to the predetermined maximum motor vehicle speed.

Thus, the motor vehicle is decelerated or slowed down to the predetermined maximum motor vehicle speed.

According to one specific embodiment of the present invention, the reduced motor vehicle speed is the predetermined maximum motor vehicle speed.

According to one specific embodiment of the present invention, it is tested if a current traffic situation permits an intervention, that is, in particular, remote control, in order, for example, to prevent other road users in the surroundings of the motor vehicle from being injured.

According to one specific embodiment of the present invention, the operation, that is, the method, in other words, the method steps, are documented in a comprehensible manner safe from falsification, for example, in a blockchain.

According to one specific embodiment of the present invention, a driver of the motor vehicle is notified that an intervention in the operation of the motor vehicle has taken place or is taking place, that is, that the motor vehicle has been controlled remotely or is being controlled remotely.

Therefore, this means, in particular, that communication signals, which represent a corresponding communication, are generated and outputted. For example, the communication signals are outputted to a human-machine interface of the motor vehicle, which means that with the aid of the human-machine interface, the driver is informed about the intervention or the remote control on the basis of the communication signals. The remote control signals include, for example, the communication signals.

In one specific embodiment of the present invention, the remote control signals include control signals for a human-machine interface of the motor vehicle, in order, in the case of remote control of the human-machine interface on the basis of the control signals, to output a signal with the aid of the human-machine interface; the signal representing the result of the comparison.

According to one specific embodiment of the present invention, the intervention or the remote control of the motor vehicle is communicated to an authority over a communications network, so that, for example, it may initiate further steps.

In one specific embodiment of the present invention, in the case of severe violations, that is, for example, when the motor vehicle speed is greater than the predetermined maximum motor vehicle speed by 10% and more, or for other reasons, then, using appropriately generated remote control signals, the motor vehicle is not only decelerated, but also stopped in a particular area. In particular, the motor vehicle may be controlled remotely in such a manner, that it is stopped in the particular area; or the driver may stop the vehicle in the particular area himself/herself, but, in so doing, is monitored by the infrastructure, so that in response to the motor vehicle's not being stopped in the area, an intervention is made remotely on the part of the infrastructure, in order to stop the motor vehicle in the particular area.

Other reasons include, for example, a spacing from a vehicle traveling ahead, which is less than or less than or equal to a predetermined minimum motor vehicle spacing value.

Other reasons include, for example, if the motor vehicle does not hold its course, that is, travels partially in other traffic lanes, but without making a proper lane change.

Other reasons include, for example, detection of other conditions not allowed, in particular, motor vehicle lighting not adapted to the visibility conditions or lighting conditions, and/or use of a cellular phone without the utilization of handsfree conversing equipment.

According to one specific embodiment of the present invention, the intervention or the remote control of the motor vehicle is communicated to an authority, so that, for example, it may initiate further steps.

According to one specific embodiment of the present invention, a condition for the remote control or for the intervention is that the remote control is safe. In the spirit of the description, “safe” means, in particular, “safe” and “secure.” Actually, these two English terms are normally translated into German as “sicker”. Nevertheless, these have a partially different meaning in English.

The term “safe” is directed, in particular, to the topic of accident and accident prevention. Remote control, which is “safe,” causes, in particular, a probability of an accident or a collision to be less than or less than or equal to a predetermined threshold probability value.

The term “secure” is directed, in particular, to the topic of computer protection and/or hacker protection, that is, in particular, how securely is an (a) (computer) infrastructure and/or a communications infrastructure, in particular, a communication path between a motor vehicle and a remote control device for controlling a motor vehicle remotely, protected from unauthorized access and/or from data manipulation by a third party (hacker).

Thus, remote control, which is “secure,” has, in particular, appropriate and sufficient computer protection and/or hacker protection as a basis.

For example, according to one specific embodiment, it is tested if the entity made up of a motor vehicle and infrastructure involved in the method according to the first aspect, including communication between the infrastructure and the motor vehicle, is currently secure for the plan, “intervention in the motor vehicle for critical actions,” described here. Therefore, this means, in particular, that the motor vehicle and/or a local and/or a global infrastructure and/or communication are appropriately tested. In particular, the remote control signals are generated on the basis of a result of the testing.

Thus, this means, in particular, that the components, which are used during the execution of the method according to the first aspect, are tested for safety, that is, as to whether these satisfy specific safety conditions, before the intervention in the vehicle operation is carried out, that is, before the motor vehicle is controlled remotely.

Important or dependent criteria include, for example, one or more of the safety conditions described above.

According to one specific embodiment of the present invention, first of all, the overall system (motor vehicle, infrastructure, communication path, cloud, . . . ) is tested with regard to the safety condition.

According to one specific embodiment of the present invention, the individual parts are also tested with regard to satisfying the safety condition. This, in particular, prior to the remote control of the motor vehicle.

In this context, in one specific embodiment of the present invention, the testing step(s) are executed inside the motor vehicle and/or outside the motor vehicle, in particular, in an infrastructure.

According to one specific embodiment of the present invention, the checking step(s) are tested subsequently, that is, at a later time, for example, at regular intervals. For example, the testing step(s) are tested subsequently at a predetermined frequency, for example, every 100 ms.

For example, according to one specific embodiment of the present invention, this testing, that is, the test as to whether the at least one safety condition is satisfied, takes place prior to and/or after and/or during one or more predetermined method steps.

According to one specific embodiment of the present invention, the testing is carried out or executed in response to problems.

What is claimed is:

1. A method for controlling a motor vehicle remotely, comprising the following steps:
receiving motor vehicle speed signals, which represent a speed of a motor vehicle;
receiving maximum motor vehicle speed signals, which represent a predetermined maximum speed of a motor vehicle;
comparing the motor vehicle speed to the predetermined maximum motor vehicle speed;
generating remote control signals for controlling the motor vehicle remotely based on a result of the comparison; and
outputting the generated remote control signals.

2. The method as recited in claim 1, wherein the remote control signals include control signals for controlling a lateral and/or longitudinal guidance of the motor vehicle, to control the lateral and/or longitudinal guidance of the motor vehicle remotely during remote control of the motor vehicle based on the remote control signals.

3. The method as recited in claim 2, wherein when the result of the comparison indicates that the motor vehicle speed is greater than the predetermined maximum motor vehicle speed, the control signals are generated in such a manner, that in the case of the remote control of the lateral and/or longitudinal guidance of the motor vehicle based on the generated remote control signals, the motor vehicle is decelerated until the motor vehicle has a reduced motor vehicle speed, which is less than or less than or equal to the predetermined maximum motor vehicle speed.

4. The method as recited in claim 2, wherein when the result of the comparison indicates that the motor vehicle speed is greater than the predetermined maximum motor vehicle speed, the control signals are generated in such a manner, that, in the case of the remote control of the lateral and/or longitudinal guidance of the motor vehicle based on the generated remote control signals, the motor vehicle stops in a predetermined area.

5. The method as recited in claim 1, wherein the remote control signals include control signals for a human-machine interface of the motor vehicle, in order, in the case of remote control of the human-machine interface based on the generated remote control signals, to output a signal using the human-machine interface, the signal representing the result of the comparison.

6. The method as recited in claim 5, wherein when the result of the comparison indicates that the motor vehicle speed is greater than the predetermined maximum motor vehicle speed, performing:
receiving, temporally subsequent to the outputting of the generated remote control signals, further motor vehicle speed signals which represent a further motor vehicle speed of the motor vehicle;
comparing the further motor vehicle speed to the predetermined maximum motor vehicle speed;
generating further remote control signals for controlling the motor vehicle remotely based on a result of the further comparison; and
outputting the generated further remote control signals.

7. The method as recited in claim 1, further comprising:
receiving surrounding-area signals, which represent a surrounding area of the motor vehicle;
wherein the remote control signals are generated based on the surrounding area.

8. The method as recited in claim 1, further comprising:
receiving safety condition signals, which represent at least one safety condition that must be satisfied, so that the motor vehicle may be controlled remotely; and
checking whether the at least one safety condition is satisfied;
wherein the remote control signals are generated based on a result of the check as to whether the at least one safety condition is satisfied.

9. The method as recited in claim 8, wherein the at least one safety condition is, in each instance, an element selected from the following groups of safety conditions:
(i) presence of a predetermined safety integrity level or automotive safety integrity level (ASIL) of at least the motor vehicle and an infrastructure, including a communication path and/or communications components, for controlling a motor vehicle remotely;
(ii) presence of a maximum latency time of a communication between the motor vehicle and a remote control device for controlling the motor vehicle remotely based on the remote control signals;
(iii) presence of a predetermined computer protection level of a device for executing the steps of the method;
(iv) presence of predetermined components and/or algorithms and/or communication options, which are used for executing the steps of the method;
(v) presence of redundancy and/or diversity in predetermined components and/or algorithms and/or communication options, which are used for executing the steps of the method according to one of the preceding claims;
(vi) presence of predetermined availability information, which indicates an availability of predetermined components and/or algorithms and/or communication options;
(vii) presence of predetermined quality criteria of the predetermined components and/or algorithms and/or communication options;
(viii) presence of a plan, which includes measures for reducing faults and/or measures in response to failures of predetermined components and/or algorithms and/or communication options and/or measures for incorrect analyses and/or measures in response to incorrect interpretations;
(ix) presence of one or more fallback scenarios;
(x) presence of a predetermined function;
(xi) presence of a predetermined traffic situation;
(xii) presence of predetermined weather,
(xiii) maximum possible time for a specific performance or execution of one or more steps of the method;
(xiv) presence of a test result, that elements or functions, which are used for executing the method, are presently functioning correctly.

10. The method as recited in claim 8, wherein the remote control signals are generated only when the at least one safety condition is satisfied.

11. The method as recited in claim 8, wherein the check as to whether the at least one safety condition is satisfied, is carried out prior to and/or after and/or during one or more predetermined steps of the method.

12. The method as recited in claim 1, further comprising:
after the outputting of the generated remote control signals, testing remote control of the motor vehicle based on the output remote control signals to detect a fault; and
in response to the detection of a fault: (i) interrupting the remote control, or (ii) generating and outputting emergency remote control signals for controlling the motor vehicle remotely in an emergency.

13. The method as recited in claim 1, wherein one or more of the steps of the method, excluding the steps of generating and outputting the remote control signals, are executed inside the motor vehicle.

14. The method as recited in claim 1, wherein one or more of the steps of the method are executed outside of the motor vehicle in an infrastructure.

15. The method as recited in claim 14, wherein the infrastructure is a cloud infrastructure.

16. The method as recited in claim 1, wherein one or more of the method steps are documented in a blockchain.

17. The method as recited in claim 1, further comprising:
testing whether an entity made up of the motor vehicle and infrastructure involved in the method, including communication between the infrastructure and the motor vehicle, is safe, so that the motor vehicle and/or a local infrastructure and/or a global infrastructure and/or communication between the motor vehicle and the infrastructure are tested.

18. A device configured for controlling a motor vehicle remotely, the device configured to:
receive motor vehicle speed signals, which represent a speed of a motor vehicle;
receive maximum motor vehicle speed signals, which represent a predetermined maximum speed of a motor vehicle;
compare the motor vehicle speed to the predetermined maximum motor vehicle speed;
generate remote control signals for controlling the motor vehicle remotely based on a result of the comparison; and
output the generated remote control signals.

19. A non-transitory machine-readable storage medium on which is stored a computer program for controlling a motor vehicle remotely, the computer program, when executed by a computer, causing the computer to perform the following steps:
receiving motor vehicle speed signals, which represent a speed of a motor vehicle;
receiving maximum motor vehicle speed signals, which represent a predetermined maximum speed of a motor vehicle;
comparing the motor vehicle speed to the predetermined maximum motor vehicle speed;
generating remote control signals for controlling the motor vehicle remotely based on a result of the comparison; and
outputting the generated remote control signals.
